(19) United States
(12) Patent Application Publication
(10) Pub. No.: US 2007/0128989 A1
(43) Pub. Date: Jun. 7, 2007

(54) Novel Grinding Tool

(75) Inventors: Christian Jentgens, Wallenwil (CH); Adrian Schoch, Warth (CH); Hans-Ulrich Kaufmann, Thundorf (CH); Rene Brunner, Waldi (CH); Peter Eggenberger, Schonenberg (CH)

Correspondence Address: SHOEMAKER AND MATTARE, LTD, 10 POST OFFICE ROAD - SUITE 110, SILVER SPRING, MD, 20910, US

(73) Assignee: SIA ABRASIVES INDUSTRIES AG, Frauenfeld (CH)

(21) Appl. No.: 11/567,789

(22) Filed: Dec. 7, 2006

(30) Foreign Application Priority Data
Dec. 7, 2005 (EP) 05111767.9
Sep. 12, 2006 (EP) 06120537.3

(51) Int. Cl. B24B 7/30; B24B 1/00; B23F 21/03

(52) U.S. Cl. 451/41; 451/56; 451/548

(57) ABSTRACT

The present invention relates to a novel grinding tool, comprising a substrate with a first water-permeable, flexible textile layer, which comprises multifilaments and to which the abrasive material has been applied, and at least one second layer, which is connected to the surface of the first layer that is free from abrasive material, can absorb water and can be compressed, the abrasive material made up of binder and abrasive grain, selected from the group comprising diamond and cubic boron nitride, being applied to the first layer in such an amount that the grinding tool has a service life of at least two minutes, preferably at least 10 and with particular preference at least 20 minutes, when working a ceramic coating surface by wet grinding.

The present invention relates to a novel grinding tool with diamond or cubic boron nitride as the abrasive material which is suitable in particular for the wet grinding of hard surfaces, for example of ceramic coatings.

The working of hard surfaces, for example of ceramic coatings in the automobile sector, by means of manual grinding tools, i.e. tools which are manually moved during the working operation, has so far not yet been satisfactorily accomplished. Conventional full-surface grinding tools have very low service lives in these processes: after working about 2 to 5 grinding locations, the grinding tool is already completely worn. It is obvious that working the entire surface of an automobile with such grinding tools is time-consuming and costly.

A further problem with conventional full-surface grinding tools is that, when working hard surfaces, the abrasive grain is quickly worn away and pieces of grain break out and come into contact with the surface to be worked. This has the consequence of undesired grinding marks (swirls) on the worked surface. This similarly takes place if hard particles of the surface become detached and are not properly picked up by the abrasive material or washed out.

For the working of hard surfaces, a very hard abrasive grain such as diamond, cubic boron nitride or boron carbide is necessary. These are quite expensive, which precludes their widespread use.

There was a need for an improved grinding tool for working hard surfaces which has longer service lives and does not leave grinding marks behind on the worked surface.

The above object was surprisingly achieved by a grinding tool comprising a substrate with
i) a first water-permeable, flexible textile layer, which comprises multifilaments and to which the abrasive material has been applied,
ii) and at least one second layer, which is connected to the surface of the first layer that is free from abrasive material, can absorb water and can be compressed,
   the abrasive material made up of binder and abrasive grain, selected from the group comprising diamond and cubic boron nitride, being applied to the first layer in such an amount that the grinding tool has a service life of at least two minutes, preferably at least 10 and with particular preference at least 20 minutes, when working a ceramic coating surface by wet grinding.

According to the present invention, wet grinding is understood as meaning that the grinding tool is moistened with water before use, for example with the aid of a hand atomizer. A person skilled in the art usually adds just enough water with the hand atomizer that not the entire surface of the workpiece is wet but specifically the area to be worked is moistened to such a degree that the grinding tool can absorb the liquid again in the compressible part. As and when required, the skilled person flushes out the compressible part by means of applying slight pressure and adds new water. Alternatively, the water could also be permanently supplied.

According to the present invention, the service life is to be understood as meaning the cumulative contact time of the grinding tool with the surface to be worked over which a desired grinding performance can be maintained. The desired grinding performance is a uniform matt appearance of the worked surface.

According to the present invention, a ceramic surface is to be understood as meaning a surface which contains ceramic constituent parts and is therefore hard. For the determination of the service life, preferably a PPG 9000 ceramic coating is worked.

It has been found that the above, significantly prolonged service lives can be achieved by a specific amount of abrasive material, a small amount in comparison with conventional grinding tools, being applied to the flexible substrate according to the invention, comprising at least two layers. Excessive application of abrasive material would lead to considerable sacrifices in flexibility and consequently in the performance of the grinding tool.

In the case of the grinding tool according to the invention, the abrasive grain is only applied superficially, i.e. the abrasive grain is only located on the portions of the first layer forming the surface, that is to say for example the lands in the case of a network structure with holes. According to the invention, it is particularly preferred that these lands are not completely coated with abrasive material.

On account of the nature of the substrate, the grinding tool according to the invention is distinguished by a high degree of flexibility. The abrasive grain resin-bonded on the surface can consequently be pressed out of the tool during the grinding operation.

This leads to significantly increased service lives and to gentler material removal from the product being worked.

In the case of wet grinding, the water supplied to the grinding tool is at least partly retained in the second layer, which can absorb water and be compressed while maintaining its shape. The grinding dust occurring during grinding can be removed in a simple way by squeezing the grinding tool. This squeezes out the water contained in the second layer, which reaches the surface of the grinding tool on account of the permeability of the grain-carrying layer and flushes away the grinding dust located on or in the surface of the grinding tool. Following this operation, which can be carried out easily and quickly, the grinding tool can be used again without any problem. However, the compression of the grinding tool occurring during the working operation is entirely sufficient to squeeze out the water present in the second layer during the working, and continuously achieve the desired removal of the grinding dust.

With the grinding tool according to the invention, grinding without grinding marks (swirls) is achieved with surprisingly long service lives. The service lives of the grinding tool according to the invention exceed the service lives of conventional full-surface grinding tools by a factor of approximately 20 to 100.

Natural or synthetic diamond or cubic boron nitride may be used as the abrasive grain, diamond being preferred not least for economical reasons.

A major aspect of the present invention is the amount of abrasive material to be applied. The present invention therefore relates to a grinding tool comprising a substrate with
i) a first water-permeable, flexible textile layer, which comprises multifilaments and has a planar surface to which the abrasive material has been applied,
ii) and at least one second layer, which is connected to the surface of the first layer that is free from abrasive material, can absorb water and can be compressed, the abrasive material made up of binder and abrasive grain, selected from the group comprising diamond and cubic boron nitride, being applied with a grain size of from 1 to 30 μm in an amount of 5-30 g/m², preferably 5-10 g/m², with respect to the wet state, and with a grain size of from 30 to 120 μm in an amount of 20-80 g/m², preferably 30-50 g/m², with respect to the wet state, the proportion of abrasive grain in the abrasive material being 40-70%.

The specified amounts of abrasive material, abrasive grain and binder relate to the amount of applied abrasive material, which is determined as follows: a substrate with a hole structure with a total surface of 100 cm² (with a proportion made up by lands (effective surface) of 33 to 50% and a proportion made up by holes of 50 to 67%) is weighed in the uncoated state. Subsequently, the abrasive material is applied, and the grinding tool obtained is weighed again in the wet state and the difference between the values ascertained is determined in order to obtain the applied amount of abrasive material in the wet state. The grinding tool is subsequently dried in an oven at 130° C. for 2 h and weighed again to obtain the applied amount of abrasive material in the dry state.

As known to a person skilled in the art, the amounts of abrasive grain and binder vary in dependence on the size of the abrasive grain. With increasing grain size, the ratio of abrasive grain to binder shifts progressively in the direction of the binder, i.e., with a fixed amount of binder, less abrasive grain is taken up as the grain size increases.

According to the present invention, in the dry state the grinding tool preferably has on its surface an amount of abrasive grain of a size of 1 to 30 μm of 2.5 to 10 g/m² (corresponds to 12.5 to 50 carats/m² of diamond) or an amount of abrasive grain of a size of 30 to 120 μm of 10 to 40 g/m² (corresponds to 50 to 200 carats/m² of diamond).

According to the present invention, the abrasive grain is bonded to the substrate by means of a resin binder. Metal-bonded abrasive materials are not covered by the present invention. The use of a so-called resin-bonded abrasive grain or “resin-bond diamond” has the advantage that it has an increased resharpening tendency (high friability).

According to the invention, all conventional resin binders can be used, for example phenolic resins (preferably with a water content of 20%), melamine resins, urea resins, epoxy resins, polyester resins, polyacrylate resins or polyurethane resins.

According to a preferred embodiment, it is particularly advantageous to use water-soluble resins, such as phenolic resins for example, which are water-soluble in the uncured state. The use of water-soluble resins allows easy recovery of abrasive grain from waste that may occur during the application process, such as by spraying for example. The residue of abrasive grain and uncured resin is simply introduced into an aqueous, preferably alkaline, solution and the resin is smoothly and efficiently separated off. This allows the application process to be carried out more quickly, without having any associated economic disadvantages (loss of abrasive grain).

It is likewise of significance according to the present invention that excessive binder is not applied to the substrate. With an excessive amount of binder on the surface of the abrasive material, the grinding tool becomes too hard and deteriorates in performance. As known to a person skilled in the art, however, the amount of binder varies in dependence on the size of the abrasive grain used. According to the invention, with preference, the amount of binder on the grinding tool in the dry state (i.e. after evaporating the solvent) is 2.5-10 g/m² if abrasive grain of a size of 1 to 30 μm is used, or 10 to 80 g/m² of binder if abrasive grain of a size of 30 to 120 μm is used.

As stated above, the substrate of the grinding tool according to the invention comprises at least two different layers.

The first layer carries the abrasive grain, which is bonded to this first layer by means of the resin binder described above. The first layer must be water-permeable, in order that the water retained in the second layer can pass through this layer and can be flushed away in or on this deposited grinding dust. The first layer also serves for strengthening the second layer. However, on the other hand it must have adequate flexibility for a compression of the second layer to be possible, to squeeze out the water retained in it while maintaining the shape of the grinding tool, and an adaptation of the grinding tool to the surface structure of the workpiece to be worked to be possible.

It has been found that the above requirements are met particularly well by flexible textile layers which comprise multifilaments. Particularly preferred are layers which are made up of a knitted fabric such as a charmeuse or a woven fabric with a 1.4 twill weave (woven fabric in which weft threads and warp threads are in a ratio of 1:4). Common knitted or woven fabrics with 1.4 twill weave may be used here. One example is that of the “Technical Fabrics for abrasive disks” of the Sitip company (Italy) (polyamide, dtex: 44). However, it is also possible for example for the first layer to be produced from a velour, from spunbonded nonwovens or needle-punched nonwovens or from a perforated full-surface support.

According to the invention, with preference, the surface of the first layer that supports the abrasive material should be planar. According to the present invention, “planar” is to be understood as meaning that the portions forming the surface of the layer (for example lands in the case of a network structure with holes) of the first layer are at substantially the same height (within the limits of customary measuring accuracy).

According to the invention, the first layer preferably has a thickness of 0.01 cm to 0.1 cm. The chosen thickness is dependent on the set of requirements and can be appropriately determined and set by a person skilled in the art without any problems.

The grinding tool according to the invention comprises at least one second layer. The second layer must be capable of absorbing and retaining water. Furthermore, the second layer must be compressible, so that the water contained in it can be squeezed out from this layer and through the first layer. However, as this happens, the second layer or the entire grinding tool must maintain its shape, i.e. revert to its original shape once the external application of force is ended. In this way it is ensured that the grinding tool according to the invention can be used again in the same way and can be freed of grinding dust, and adapts itself to the conditions of the surface of the workpiece to be worked.

It has been found that conventional flexible foams meet the above requirements very well. According to a preferred embodiment, the second layer of the substrate of the grinding tool according to the invention consequently consists of a flexible foam. Flexible foams are known to a person skilled in the art. Open-cell polyether-polyurethane foam may be mentioned as an example.

According to a further embodiment, the second layer may comprise a number of sublayers, preferably two sublayers. An example of this is that of the “3D Spacer fabrics” of the Scott & Fyve company (United Kingdom), a product comprising two fabric layers inseparably woven together. Although in this example the sublayers do not consist of foam, two sublayers of foam can of course also be used.

According to the invention, the second layer (or the entirety of sublayers which together form the second layer) generally has a thickness of 0.2 cm to 1 cm. The chosen thickness is dependent on the set of requirements and can be appropriately determined and set by a person skilled in the art without any problems.

The first and second layers may be connected to each other in a conventional and known way, for example by adhesive bonding, flame bonding or by means of a Velcro connection. In the latter case, only the first, grain-carrying layer is laminated with a velour. The second layer then takes the form of a reusable intermediate pad. However, the connection must in any event be water-permeable.

While the grinding tool according to the invention is being used, the two layers are connected to each other. However, it is both possible to connect the two layers permanently to each other and to make the connection only immediately before use. In the latter case, it is possible to provide the second layer on the holder of a grinding appliance and connect it to the unit comprising the first layer and abrasive grain located thereupon before use—advantageously by means of a releasable connection such as a Velcro connection. As a result, easy exchange of the first layer, carrying the abrasive grain, is also possible.

Accordingly, the present invention also relates to the use of a unit made up of a water-permeable, flexible textile layer which comprises multifilaments and on which an abrasive material made up of binder and abrasive grain, selected from the group comprising diamond and cubic boron nitride, is applied in a grinding tool according to the invention as described above.

The present invention also relates to the use of a unit made up of a layer which can absorb water, can be compressed while maintaining its shape and has a water-permeable, self-adhesive layer on at least one side in a grinding tool according to the invention as described above.

In order to be able to fasten the grinding tool according to the invention on a holder of a grinding appliance, the surface of the second layer that is facing away from the surface carrying the first layer is designed in such a way that it is self-adhesive. This can take place by a layer of conventional velour (for example of nylon) or Velcro or an adhesive layer being provided on the corresponding surface of the second layer. Such layers and ways of applying them are known from the prior art and do not require any further explanation.

The grinding tool according to the invention is suitable in particular for working surfaces which contain constituent parts of ceramic. Surface materials to be treated that may be mentioned by way of example are: ceramic surfaces per se, ceramic coatings on wood (for example sealed parquet floors), technical glasses, glass, composite materials based on stone or minerals, fibre-containing composite such as glass-fibre reinforced plastics (GRP) or carbon-fibre reinforced plastics (CRP) or aramid-fibre reinforced plastics, or “superhard” coatings such as epoxy coatings.

The grinding tool according to the invention is preferably provided here in the form of discs or strips, in order to be applied to conventional portable grinders, such as for example eccentric grinders.

The grinding tool according to the invention can be produced by applying the abrasive grain with the resin binder to the first layer of the substrate by a pressureless coating method. Known pressureless coating methods are, for example, spray coating, dip coating (or kiss coating), air knife or transfer methods.

As already described above, it is also advantageous here if a resin binder that is water-soluble in the uncured state is used. It is then not necessary to take special care in the application process that the expensive abrasive grain reaches the substrate surface as completely as possible. Rather, high-speed methods such as overspraying of the substrate (beyond the surface to be coated) can be carried out, if a collecting device such as a pan is provided alongside and underneath the substrate to be connected. The mixture of abrasive grain and uncured binder collected there can subsequently be easily separated by adding an aqueous, with preference alkaline, solution, in particular in the pH range of pH=10, and dissolving the binder in it. The abrasive grain can then be separated off (for example filtered off) without any problem.

According to the invention, with particular preference, the grinding tool is produced by only the surface of the first layer being coated by the kiss method. In particular in the case of a substrate with a hole network structure, the amount applied can in this case be exactly metered. Grinding tools obtainable in this way are the subject of the present invention.

The surface treatment with the grinding tools according to the invention is carried out by the wet grinding method, preferably with a hand atomizer. A person skilled in the art usually adds just enough water with the hand atomizer that not the entire surface of the workpiece is wet but specifically the area to be worked is moistened to such a degree that the grinding tool can absorb the liquid again in the compressible part. As and when required, the skilled person flushes out the compressible part by means of applying slight pressure and adds new water.

The grinding tool according to the invention is explained in more detail below on the basis of non-restrictive figures and examples.

In the figures:

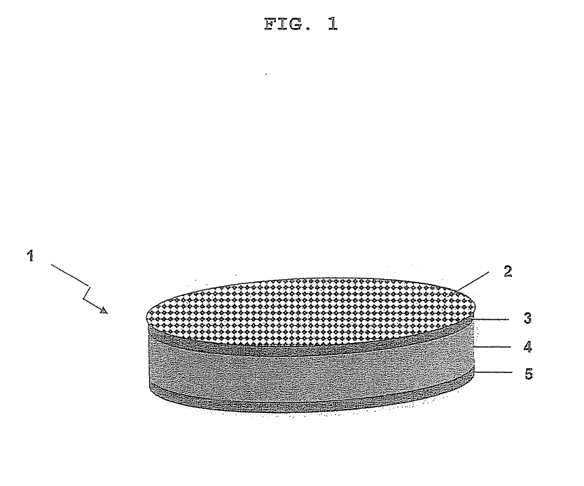

FIG. 1 shows a schematic view of an embodiment of the grinding tool according to the invention

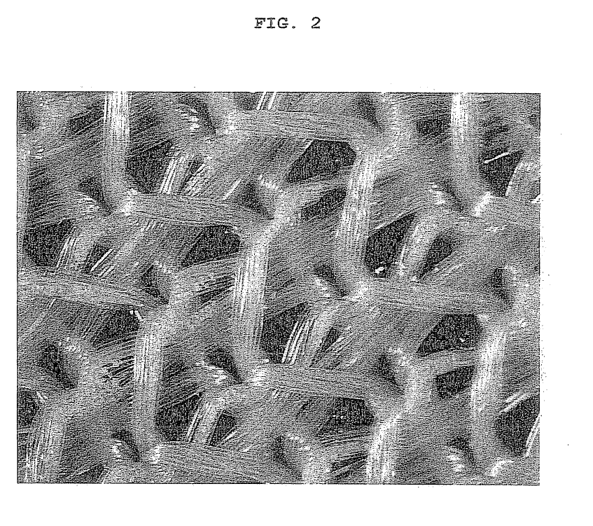

FIG. 2 shows a plan view of the surface of an embodiment of the grinding tool according to the invention that has the abrasive material

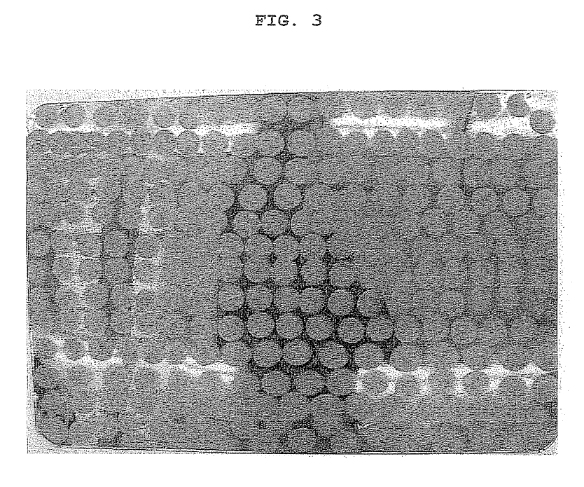

FIG. 3 shows the result of punctiform surface working of a ceramic coating with the grinding tool according to the invention over a period of time of 20 minutes

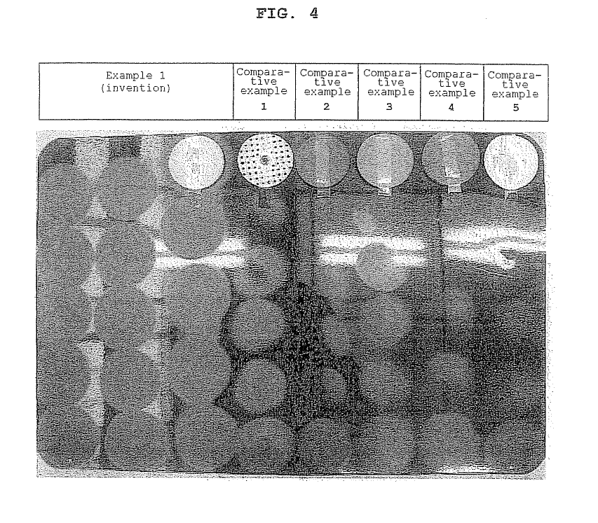

FIG. 4 shows the result of a comparative test with the grinding tool according to the invention and conventional grinding tools.

In FIG. 1, a grinding tool 1 according to the invention is shown. The grinding tool has resin-bonded diamond 2 as abrasive grain. The binder resin is preferably a phenolic resin. The diamond is located on the elevations (lands) of the first layer 3, preferably made up of a knitted fabric. The first layer is water-permeable and preferably has a planar surface. The first layer is located on a second layer 4, which can absorb water and can be compressed while maintaining its shape. This second layer 5 preferably consists of a flexible foam. The two layers are connected to each other by means of a water-permeable connection. On the remote surface of the second layer 4 there is a layer 5, which makes the substrate of the grinding tool self-adhesive. The layer 5 is preferably a Velcro layer or layer made up of an adhesive.

In FIG. 2, a plan view of a grinding tool according to the invention is shown. It can be seen that a comparatively small amount of abrasive grain has been applied to the lands of the surface of the first substrate layer.

### EXAMPLE

An about 70% phenol-formaldehyde solution (pre-condensate) was applied together with a commercially available integrated wetting agent and with diamond (grain 1000) as the abrasive grain by means of the kiss coating method to a knitted substrate (charmeuse SB780, proportion made up by lands approximately ⅓ to ½ of the surface). The knitted substrate was applied by flame bonding to a foam layer (6 mm thick, 40 kg/m² apparent density, with the velour layer 55 kg/m³ applied thereupon) made up of polyether-polyol rapidly expanding again after compression (analogous results were obtained with a foam layer made up of polyether-polyurethane rapidly expanding again after compression). A velour layer had been applied to the other surface of the foam layer by flame bonding. The application of the layer of abrasive material was in this case 2.5-5 g/m² of binder and 2.5-5 g/m² of diamond (grain 1000). The applied layer was subsequently cured in an oven at 130° C. for 2 h.

The grinding performance of the grinding tool produced in this way was determined on the basis of 30 mm discs with an eccentric grinder. The surface of the grinding tool having the abrasive material was moistened as described above with a hand atomizer. The grinding tool was used to grind for 5 s at the same location on a scratch-resistant ceramic coating (PPG 9000), before moving on to work another location. If after such working the ground location appears matt, the grinding performance is considered to be good.

In FIG. 3, the result of such a test with the grinding tool according to example 1 over a period of time of 20 minutes is shown. With the grinding tool according to the invention, it was possible in this way to work far in excess of 100 locations with a very good grinding result. After 20 minutes of cumulative contact time between the grinding tool and the worked surface, the test was ended, without the grinding tool according to the invention being unserviceable at this time. The grinding tool according to the invention consequently had a service life of over 20 minutes.

For comparison, the same grinding treatment was carried out with different conventional grinding tools of various kinds. The results are shown in FIG. 4.

The comparative examples 1 and 5 concern different grinding tools with corundum as the abrasive grain on a paper substrate (comparative example 1: Norton A975 (P400) of the Norton company; comparative example 5: siamic1990 (P1000) of the sia abrasives company). The comparative examples 2 and 3 concern grinding tools with a substrate corresponding to the grinding tool according to the invention, but with corundum and silicon carbide respectively as the abrasive grain (comparative example 2: Abralon (K1000) of the Mirka company with silicon carbide as the abrasive grain; comparative example 3: siaair velvet (K1000) with corundum as the abrasive grain of the sia abrasives company). Comparative example 4 was a grinding tool with corundum as the abrasive grain on a substrate of nonwoven fabric (siavlies (K6000) of the sia abrasives company).

As can be seen from FIG. 4, the grinding performance of the comparative examples deteriorated after only a few locations. A continuous matt effect (and consequently good grinding performance) of the worked locations was no longer detectable after working any more than 3 locations in the case of any of the comparative examples. The corresponding grinding tools were consequently unserviceable much more quickly than the grinding tool according to the invention.

1. A grinding tool comprising a substrate with
i) a first water-permeable, flexible textile layer, which comprises multifilaments and to which abrasive material has been applied, and
ii) at least one second layer, which is connected to the surface of the first layer that is free from abrasive material, and which can absorb water and can be compressed,
wherein said abrasive material is made up of binder and abrasive grain selected from the group consisting of diamond and cubic boron nitride, and wherein said material is applied to the first layer in such an amount that the grinding tool has a service life of at least two minutes, when working a ceramic coating surface by wet grinding.

2. A grinding tool comprising a substrate with
i) a first water-permeable, flexible textile layer, which comprises multifilaments and has a planar surface to which abrasive material has been applied, and
ii) at least one second layer, which is connected to the surface of the first layer that is free from abrasive material, and which can absorb water and can be compressed,
wherein said abrasive material is made up of binder and abrasive grain, selected from the group consisting diamond and cubic boron nitride, and wherein said abrasive material is applied with a grain size of from 1 to 30 μm in an amount of 5-30 g/m², with respect to the wet state, and with a grain size of from 30 to 120 μm in an amount of 20-80 g/m², with respect to the wet state, the proportion of abrasive grain in the abrasive material being 40-70%.

3. Grinding tool according to claim 1, wherein the service life is at least 10 minutes.

4. Grinding tool according to claim 1, wherein the service life is at least 20 minutes.

5. Grinding tool according to claim 2, wherein said abrasive material is applied with a grain size of from 5-10 μm in an amount of from 5-10 g/m².

6. Grinding tool according to claim 2, wherein said abrasive material is applied with a grain size of from 30-120 μm in an amount of from 30-80 g/m².

7. Grinding tool according to claim 1, wherein in the dry state the tool has an amount of abrasive grain of a size of 1 to 30 μm of 2.5 to 10 g/m² or an amount of abrasive grain of a size of 30 to 120 μm of 10 to 40 g/m².

8. Grinding tool according to claim 1, wherein in the dry state the tool has an amount of 2.5-10 g/m² of binder if abrasive grain of a size of 1 to 30 μm is used, or 10 to 80 g/m² of binder if abrasive grain of a size of 30 to 120 μm is used.

9. Grinding tool according to claim 1, wherein the first and second layers are fixedly or releasably connected to each other.

10. Grinding tool according to claim 1, wherein the resin binder is selected from the group consisting of phenolic resins, melamine resins, urea resins, epoxy resins, polyester resins, polyacrylate resins and polyurethane resins and mixtures thereof.

11. Grinding tool according to claim 6, wherein the resin binder is water-based.

12. Grinding tool according to claim 1, wherein the first layer is made up of a knitted fabric or a woven fabric with a 1.4 twill weave or a velour.

13. Grinding tool according to claim 1, wherein the second layer is made up of a flexible foam.

14. Grinding tool according to claim 1, wherein the second layer is made up of a number of sublayers.

15. Grinding tool according to claim 1, wherein the substrate is self-adhesive on the side facing away from the abrasive material.

16. Grinding tool according to claim 5, wherein to achieve self-adhesion on the surface of the second layer which is facing away from the surface carrying the first layer, a layer of conventional velour or Velcro or an adhesive layer is provided.

17. Method for producing a grinding tool according to claim 1, wherein the abrasive grain is applied with the resin binder to the first layer of the substrate by a pressureless coating method.

18. Method according to claim 17, wherein the pressureless coating method is selected from the group comprising spray coating, dip coating (kiss coating), air knife and transfer methods.

19. Method according to claim 17, wherein the surface of the first layer is coated with abrasive material by the kiss method.

20. Method according to claim 17, wherein the mixture of resin binder and abrasive grain that does not reach the substrate is collected and the abrasive grain is recovered by dissolving the binder in an aqueous solution.

21. Grinding tool obtainable by a method according to claim 17.

22. Method of use of a grinding tool according to claim 1 for the treatment of surfaces which contain ceramic constituent parts.

23. Method of use according to claim 22, wherein the surface material to be treated is a material which is selected from the group consisting of ceramic surfaces per se, ceramic coatings on wood, technical glasses, glass, composite materials based on stone or minerals, fibre-containing composites, or epoxy coatings.

24. Method of use according to claim 22, the surface treatment taking place by a wet grinding method.

26. Method of use of a unit made up of a water-permeable, flexible textile layer which comprises multifilaments and on which an abrasive material made up of binder and abrasive grain, selected from the group consisting of diamond and cubic boron nitride, is applied in a grinding tool according to claim 1.

27. Method of use of a unit made up of a layer which can absorb water, can be compressed and has a water-permeable, self-adhesive layer on at least one side in a grinding tool according to claim 1.
